(19) United States
(12) Patent Application Publication
(10) Pub. No.: US 2025/0362163 A1
(43) Pub. Date: Nov. 27, 2025

(54) TRANSDUCER, MANUFACTURING METHOD AND FLOW MEASUREMENT DEVICE

(71) Applicant: Mezolen Instrument (ChangZhou) Co., Ltd., Changzhou (CN)

(72) Inventor: Zhongzhou Wang, Changzhou (CN)

(21) Appl. No.: 19/294,321

(22) Filed: Aug. 8, 2025

Related U.S. Application Data
(63) Continuation of application No. PCT/CN2023/099072, filed on Jun. 8, 2023.

(30) Foreign Application Priority Data
Feb. 9, 2023 (CN) 202310090885.8

(51) Int. Cl. G01F 1/667; G01F 15/18

(52) U.S. Cl. CPC G01F 1/667; G01F 15/185

(57) ABSTRACT

The present invention relates to the field of flow measurement technologies, specifically to a transducer, manufacturing method and flow measurement device. It comprises a body and an acoustic communication rod, wherein the body is fixedly connected to the acoustic communication rod, and the radiating surface of the body abuts against one end of the acoustic communication rod, thereby achieving signal transmission. The key feature is that the acoustic matching layer of the body is made of a composite material comprising silver and epoxy resin. The composite material contains 2 to 4 parts by weight of silver powder and 6 to 8 parts of AB adhesive. This transducer exhibits excellent electrical performance and superior acoustic matching effect, resulting in minimal measurement error when applied in a flow measurement device.

### CROSS REFERENCE TO RELATED APPLICATIONS

The present application is a Continuation Application of PCT Application No. PCT/CN2023/099072 filed on Jun. 8, 2023, which claims the benefit of Chinese Patent Application No. 202310090885.8 filed on Feb. 9, 2023. All the above are hereby incorporated by reference in their entirety.

### TECHNICAL FIELD

The present invention relates to the field of flow measurement technologies, and more particularly to a transducer, its manufacturing method, and an ultrasonic flow measurement device.

### BACKGROUND

An ultrasonic flowmeter is a device that measures the flow rate of fluid within a pipeline using the transit-time method principle. By measuring the time taken for ultrasonic pulses to travel between two ultrasonic bodies in both upstream and downstream directions of the fluid, the fluid velocity inside the pipe can be determined, and the flow rate of the fluid is calculated accordingly. An ultrasonic flowmeter mainly comprises a main unit and transducers, wherein the lead wires of the transducers are connected to the main unit. Each transducer includes a body and an acoustic communication rod, with the body being fixedly connected to the acoustic communication rod, and the radiating surface of the body abutting one end of the acoustic communication rod, thereby achieving signal transmission.

Currently, in traditional transducers, the acoustic matching layer is made of plastic, peek, or low-viscosity epoxy resin. However, due to the inherent characteristics of plastic, peek, or low-viscosity epoxy resin, the acoustic matching layer made from these materials exhibits poor electrical performance and suboptimal acoustic matching, resulting in significant measurement errors in the flow measurement device.

### SUMMARY

The technical problem to be solved by the present invention is to provide a transducer, a manufacturing method, and a flow measurement device, wherein the transducer exhibits excellent electrical performance, superior acoustic matching effect, and minimal measurement error.

To address the aforementioned problem, the following technical solution is adopted:

A transducer, comprising a body and an acoustic communication rod, wherein the body is fixedly connected to the acoustic communication rod, and the radiating surface of the body abuts against one end of the acoustic communication rod thereby achieving signal transmission; characterized in that the acoustic matching layer of the bod is made of a composite material comprising silver and epoxy resin; the composite material contains 2 to 4 parts by weight of silver powder and 6 to 8 parts of ab adhesive.

The body comprises a housing and a lead wire, wherein the housing includes a support cylinder, a cylindrical backing is concentrically arranged within the support cylinder, the inner end surface of the backing is a smooth plane, and the outer end surface is irregular with surface pits and dents; a piezoelectric ceramic plate, serving as an acoustic transmitting and receiving element, is adhered to the inner end of the backing; the acoustic matching layer is positioned between the piezoelectric ceramic plate and the bottom of the inner cavity of the support cylinder; a limiting mechanism is provided between the backing and the inner cavity of the support cylinder, ensuring that the backing, piezoelectric ceramic plate, and acoustic matching layer are fixed inside the support cylinder; one end of the backing is connected to the lead wire, while the other end of the lead wire passes through the opening of the support cylinder and extends outward; the outer end surface of the bottom of the support cylinder serves as the radiating surface.

The limiting mechanism comprises a limiting sleeve and a compression nut; the limiting sleeve is sleeved between the piezoelectric ceramic plate and the backing, with the outer circumferential surface of the limiting sleeve abutting the outer side of the support cylinder; an internal thread is formed on the inner circumferential surface of the opening of the support cylinder, the compression nut is located within the opening of the support cylinder and threadedly connected thereto, and a compression spring is arranged between the inner side surface of the compression nut and the outer end of the backing.

The connecting post extending outward is concentrically arranged on the outer end surface of the backing, wherein the outer end of the connecting post is provided with a threaded hole arranged radially relative to the support cylinder. A bolt is inserted into the threaded hole, and one end of the lead wire is positioned between the bolt and the connecting post. The compression nut is provided with a clearance hole through which the lead wire passes. The other end of the lead wire passes through the clearance hole and the opening of the support cylinder to extend outward.

The rubber block is filled inside the portion of the support cylinder located outside the compression nut, and the lead wire passes through the rubber block.

The acoustic communication rod comprises a long tube, one end of which, near the body, is sealed. A transmission part made of cylindrical wires or thin sheets is filled inside the long tube, with one end of the transmission part abutting against the inner surface of the sealed end of the long tube. The other end of the transmission part is fixedly provided with a connecting plate, which is positioned outside the open end of the long tube. A protective cover is provided between the outer side of the connecting plate and the open end of the long tube. A connecting sleeve is sleeved over the sealed end of the long tube, with the inner end of the connecting sleeve sleeved over the outer side of the long tube, and they are fixedly connected. Vent holes are arranged axially between the inner wall of the connecting sleeve and the outer wall of the long tube. The bottom end of the support cylinder extends from the outer end of the connecting sleeve into its interior.

A manufacturing method for the transducer, characterized by comprising the following steps:

Step one: Separately manufacture the body and the acoustic communication rod.

Manufacturing the body: Separately prepare the support cylinder, piezoelectric ceramic plate, backing, compression spring, limiting sleeve, compression nut, lead wire, and bolt.

The process of connecting the connecting post and the lead wire is as follows: One end of the lead wire is wound around the bolt, then the bolt is screwed into the threaded hole, thereby clamping the lead wire onto the connecting post.

The installation process is as follows:

A. Prepare the acoustic matching layer at the bottom of the inner cavity of the support cylinder: First, mix 2 to 4 parts by weight of silver powder into 6 to 8 parts of ab adhesive and stir evenly to obtain a gel-like composite material. Then, uniformly coat the composite material onto the bottom of the inner cavity of the support cylinder, with a coating thickness of one-quarter of the wavelength of the ultrasonic wave. After the composite material coated inside the support cylinder has dried, the acoustic matching layer is formed.

B. After the preparation of the acoustic matching layer is completed, sequentially insert the limiting sleeve, piezoelectric ceramic plate, backing 108, compression spring, and compression nut into the support cylinder. Pass the outer end of the lead wire through the clearance hole to the outside of the support cylinder. Then, tighten the compression nut, causing the compression spring to be compressed, thereby fixing the backing inside the support cylinder.

C. Inject high-temperature sealing adhesive into the portion of the support cylinder located outside the compression nut. After cooling, the high-temperature sealing adhesive forms the rubber block, thereby completing the body.

For the acoustic communication rod: Separately prepare the long tube, transmission part, connecting plate, protective cover, and connecting sleeve. The installation process is as follows:

The connection process of the transmission part, connecting plate, protective cover, and the long tube is as follows:

A. Weld one end of each cylindrical wire or thin sheet in the transmission part sequentially and evenly onto the connecting plate.

B. After cryogenic treatment, insert the transmission part into the long tube.

C. Fix the protective cover to the open end of the long tube. As the temperature rises, the transmission part expands and closely fits with the inner cavity of the long tube, with the protective cover abutting against the connecting plate.

The connection process of the connecting sleeve and the long tube is as follows: Sleeve the connecting sleeve over the outer side of the sealed end of the long tube, and fix the connecting sleeve to the long tube by welding. During the welding process, ensure that a gap is formed between one side of the connecting sleeve and the long tube, thereby forming the vent holes.

Step two: Installation of the body and the acoustic communication rod

First, apply coupling material evenly on both the outer surface of the bottom end of the support cylinder and the outer surface of the sealed end of the long tube. Then, insert the bottom end of the support cylinder into the connecting sleeve. The support cylinder and the connecting sleeve are fixedly connected by threads or clamps, with the bottom end of the support cylinder abutting against the sealed end of the long tube. Under pressure, the coupling agent flows into the gap, thereby expelling the air between the support cylinder, the long tube, and the connecting sleeve into the gap, ensuring that the radiating surface of the body and the acoustic communication rod are tightly fitted together, thereby guaranteeing stable signal transmission.

An ultrasonic flow measurement device, comprising a main unit and no fewer than two transducer groups, each transducer group including two transducers, wherein the lead wires of the transducers are connected to the main unit. The transducers are any one of the transducers described above.

By employing the above solution, the following advantages are achieved:
1. the acoustic matching layer of the transducer in the present invention is made of a mixed material composed of silver and epoxy resin. This mixed material possesses superior electrical properties and excellent acoustic matching performance, thereby ensuring accurate measurement results of the flow measurement device utilizing this transducer.
2. the rear surface of the backing in the transducer of the present invention is designed with an irregular, pitted texture. This irregular surface effectively suppresses the propagation of ultrasonic waves within the backing, achieving a diffuse reflection effect, which ultimately provides acoustic damping to ensure a high signal-to-noise ratio snr. Traditional backings with smooth surfaces result in lower snr. Although existing technologies also achieve acoustic damping by compounding multiple materials and incorporating acoustic damping substances to create a high-snr backing, such composite processes are complex. In contrast, the backing of the present invention is directly machined from existing graphite bronze material, eliminating the need to first produce composite materials, thus significantly simplifying the manufacturing process.
3. the transducer of the present invention is designed with vent holes between the connecting sleeve and the long tube. The presence of these vent holes allows the coupling agent applied between the support cylinder and the long tube to flow into the vent holes during assembly, thereby expelling air from between the bottom end of the support cylinder and the sealed end of the long tube. This ensures a tight fit between the support cylinder and the long tube, guaranteeing strong acoustic signal reception by the transducer, reducing measurement errors, and enhancing measurement stability.

### BRIEF DESCRIPTION OF THE DRAWINGS

FIG. 1 is a schematic structural diagram of the transducer of the present invention.

FIG. 2 is a cross-sectional schematic view of the body in the transducer of the present invention.

FIG. 3 is a schematic structural diagram of the backing in the transducer of the present invention.

FIG. 4 is a cross-sectional view of the acoustic communication rod in the transducer of the present invention transmission part made of thin sheets.

FIG. 5 is an end-view schematic diagram of the transmission part with a thin-sheet structure in the transducer of the present invention.

FIG. 6 is a cross-sectional schematic view showing the connection between the body and the acoustic communication rod in the transducer of the present invention.

FIG. 7 is a schematic structural diagram of the flow measurement device of the present invention.

FIG. 8 is a comparative diagram illustrating the snr between the transducer of the present invention and a transducer with a flat-surfaced backing.

FIG. 9 is a comparative diagram of acoustic signal strength received by the transducer of the present invention versus a transducer without vent holes.

FIG. 10 is a comparative diagram of acoustic signals between the transducer of the present invention and a conventional transducer.

### DETAILED DESCRIPTION OF THE EMBODIMENT

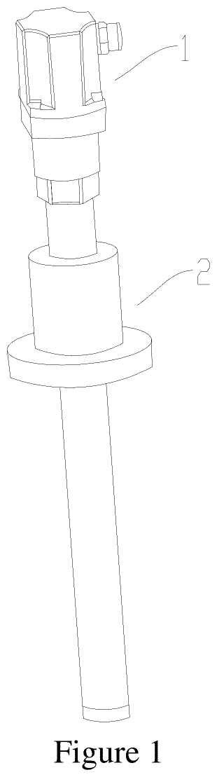

The present invention will be described in further detail below in conjunction with FIGS. 1-10 and the following embodiments.

### Embodiment 1

As shown in FIG. 1, the transducer of the present invention comprises a body 1 and an acoustic communication rod 2. The body 1 is a piezoelectric transducer. The body 1 and the acoustic communication rod 2 are in a fixed connection, with the radiating surface of the body 1 abutting one end of the acoustic communication rod 2, thereby enabling signal transmission. The acoustic matching layer 1010 of the body 1 is made of a mixed material composed of silver and epoxy resin. The mixed material contains 3 parts silver powder and 7 parts ab glue by weight ratio. This mixed material exhibits superior electrical performance and excellent acoustic matching effect, thus ensuring accurate measurement results for the flow measurement device utilizing this transducer. The acoustic communication rod 2 serves to distance the body 1 from the medium, thereby preventing the transducer from being affected by the temperature and pressure of the medium.

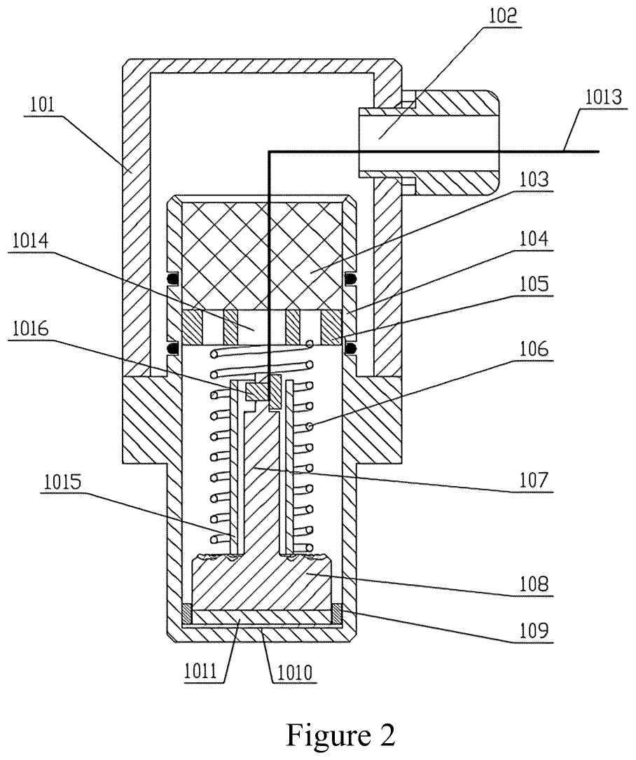

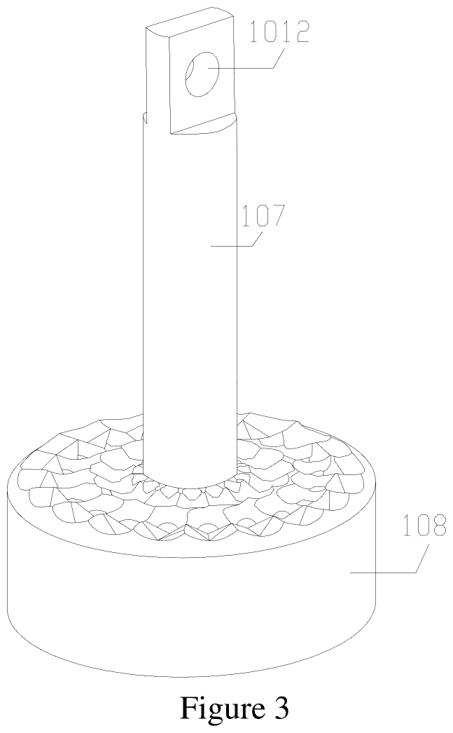

As shown in FIGS. 2 and 3, the body 1 comprises a housing and a lead wire 1013. The housing includes a support cylinder 104, within which a cylindrical backing 108 is concentrically arranged. The inner end face of the backing 108 is a smooth plane, while its outer end face features an irregular, pitted surface. This irregular outer surface can suppress ultrasonic waves on the back side of the backing 108, inhibiting the propagation of ultrasonic waves within the backing 108, thereby achieving a diffuse reflection effect, which ultimately provides acoustic damping. This, in turn, reduces oscillation in the original signal, minimizes after-pulses, and enhances sensitivity and narrow pulse characteristics.

The inner end of the backing 108 is covered with a piezoelectric ceramic plate 1011, which serves as the acoustic transmitting and receiving element. The ceramic plates are available in flanged and non-flanged versions. To achieve better piezoelectric performance, the present invention employs non-flanged piezoelectric ceramics to manufacture the piezoelectric ceramic plate 1011.

The acoustic matching layer 1010 is located between the piezoelectric ceramic plate 1011 and the bottom of the inner cavity of the support cylinder 104. A limiting mechanism is provided between the backing 108 and the inner cavity of the support cylinder 104, thereby securing the backing 108, piezoelectric ceramic plate 1011, and acoustic matching layer 1010 within the support cylinder 104. The limiting mechanism includes a limiting sleeve 109 and a compression nut 105. The limiting sleeve 109 is sleeved between the piezoelectric ceramic plate 1011 and the backing 108, with its outer peripheral surface abutting against the outer side of the support cylinder 104. An internal thread is formed on the inner peripheral surface of the opening of the support cylinder 104, with the compression nut 105 located within the opening and connected to the support cylinder 104 via a threaded connection. A compression spring 106 is positioned between the inner side surface of the compression nut 105 and the outer end of the backing 108. The limiting sleeve 109 radially limits the backing 108, ensuring that the backing 108 remains centered within the support cylinder 104. The limiting sleeve 109 acts as a structural component to secure the backing 108, but does not participate in effective acoustic signal transmission. Furthermore, it must exhibit high and low temperature resistance properties; thus, materials such as ptfe teflon or peek are selected. In this embodiment, the limiting sleeve 109 is made of ptfe teflon. During the tightening process of the compression nut 105, the compression spring 106 is compressed, and its force ensures tight engagement between the backing 108 and the piezoelectric ceramic plate 1011, as well as between the piezoelectric ceramic plate 1011 and the acoustic matching layer 1010. A gel block 103 is arranged within the support cylinder 104 above the compression nut 105 to provide secondary positioning.

The outer end surface of the backing plate 108 is concentrically provided with a connecting post 107 protruding outward. A threaded hole 1012 is arranged radially on the outer end of the connecting post 107. A bolt 1016 is engaged within the threaded hole 1012, with one end of the lead wire 1013 positioned between the bolt 1016 and the connecting post 107. The pressing lock nut 105 is provided with a clearance hole 1014 for the passage of the lead wire 1013. The other end of the lead wire 1013 extends outward through the clearance hole 1014 and the opening of the supporting cylinder 104. To facilitate the contact between the lead wire 1013 and the connecting post 107, the upper end of the connecting post 107 is machined with two parallel planar surfaces. The two ends of the threaded hole 1012 are located respectively on these two planar surfaces, as shown in FIG. 3.

In this embodiment, a protective tube 1015 made of teflon is disposed between the compression spring 106 and the connecting post 107. The protective tube 1015 is sleeved onto the connecting post 107, with the outer sidewall of the protective tube 1015 abutting against the inner sidewall of the compression spring 106. The round protective tube 1015 guides the compression spring 106 to prevent deformation of the compression spring 106.

For better protection of the core components of the body 1, an upper cover 101 is provided at the open end of the supporting cylinder 104. The upper cover 101 is in a fixed connection with the supporting cylinder 104. A lead hole 102 is formed on the sidewall of the upper cover 101 to facilitate the passage of the lead wire 1013.

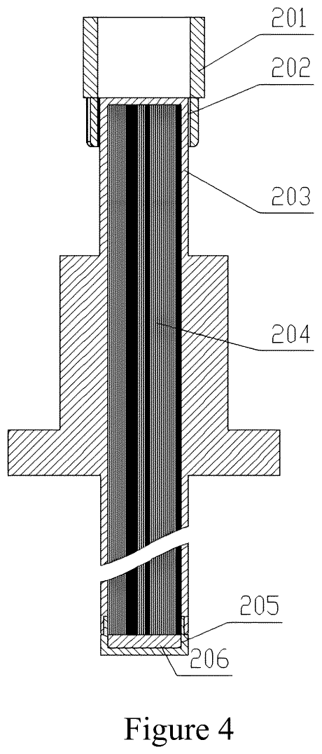

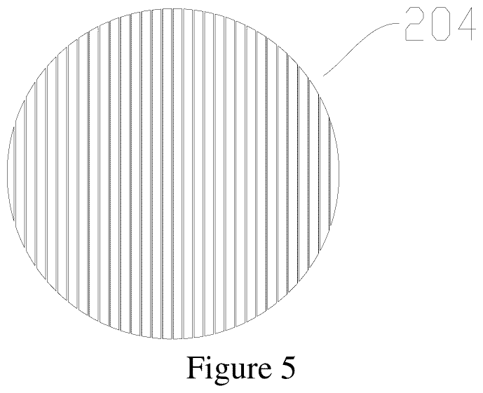

As shown in FIG. 4, the acoustic communication rod 2 includes a long pipe 203. One end of the long pipe 203, adjacent to the body 1, is closed. Inside the long pipe 203 is filled with a transmission section 204 made of cylindrical wires or thin sheets, as illustrated in FIG. 5. Through testing and experimentation, it has been found that when using 316ss material, cylindrical wires with a radius of 0.5 mm or steel strips with dimensions of 1 mm in thickness and 15 mm in width provide the best acoustic transmission performance. In this embodiment, the transmission section 204 is made of steel strips with a thickness of 1 mm and a width of 15 mm.

As shown in FIG. 4, one end of the transmission section 204 abuts against the inner surface of the closed end of the long pipe 203. The other end of the transmission section 204 is fixed with a connecting plate 206, which is made of silver. The connecting plate 206 is located outside the open end of the long pipe 203. A protective cover 205 is provided between the outer side of the connecting plate 206 and the open end of the long pipe 203. The protective cover 205 is made of 316ss. The protective cover 205 is fixedly connected to the open end of the long pipe 203 via threading. The closed end of the long pipe 203 is sleeved with a coupling sleeve 201. The inner end of the coupling sleeve 201 is sleeved over the outer side of the long pipe 203, and the two are in a fixed connection. There are vent holes arranged axially along the acoustic communication rod 2 between the inner sidewall of the coupling sleeve 201 and the outer sidewall of the long pipe 203. The bottom end of the supporting cylinder 104 is inserted into the coupling sleeve 201 from its outer end.

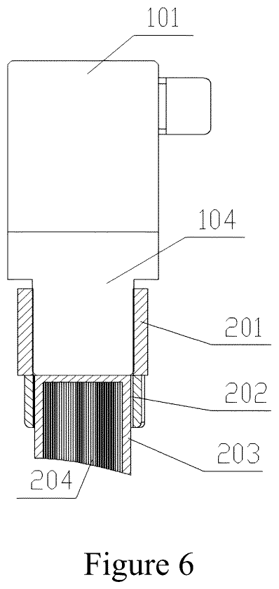

As shown in FIG. 6, the supporting cylinder 104 and the coupling sleeve 201 are in a fixed connection, either via threading or a clamping structure. For the clamping structure, reference can be made to Chinese patent application no. 2022103031383. In this embodiment, the body 1 and the acoustic communication rod 2 are connected by threading. The outer surface at the bottom end of the supporting cylinder 104 is machined with external threads, while the inner surface of the coupling sleeve 201 is machined with internal threads. The bottom end of the supporting cylinder 104 is screwed into the coupling sleeve 201 until the bottom end face of the supporting cylinder 104 abuts against the closed end of the long pipe 203.

In this embodiment, the preparation method of the transducer comprises the following steps:

Step one: Separately manufacture the body and the acoustic communication rod.

Manufacturing of body 1: Separately prepare the supporting cylinder 104, piezoelectric ceramic plate 1011, backing plate 108, compression spring 106, limiting sleeve 109, pressing lock nut 105, lead wire 1013, bolt 1016, and protective tube 1015.

The supporting cylinder 104 is processed from ss316 or titanium alloy. In this embodiment, the supporting cylinder 104 is made of titanium alloy. The piezoelectric ceramic plate 1011 is fabricated from unflanged piezoelectric ceramics. The limiting sleeve 109 is made of teflon. The backing plate 108 and connecting post 107 are integrally machined from graphite bronze. Subsequently, a threaded hole 1012 is machined at the upper end of the connecting post 107, followed by silver plating treatment to complete the component. The advantage of integrally machining the backing plate 108 and connecting post 107 is to avoid welding, thereby preventing issues such as silver film detachment caused by welding defects.

The connection process between the connecting post 107 and the lead wire 1013 is as follows: Wrap one end of the lead wire 1013 around the bolt 1016, then insert the bolt 1016 into the threaded hole 1012, thus pressing the lead wire 1013 tightly onto the connecting post 107.

The installation process is as follows:
A. Prepare the acoustic matching layer 1010 at the bottom of the inner cavity of the support cylinder 104: First, mix 2 to 4 parts by weight of silver powder into 6 to 8 parts of ab adhesive and stir evenly to obtain a gel-like composite material. Then, uniformly coat the composite material onto the bottom of the inner cavity of the support cylinder 104, with a coating thickness of one-quarter ¼ of the wavelength of the ultrasonic wave. After the composite material coated inside the support cylinder 104 has dried, the acoustic matching layer 1010 is formed. The ab adhesive consists of 1 part a adhesive and 3 parts b adhesive by mass.
B. After the preparation of the acoustic matching layer 1010 is completed, sequentially insert the limiting sleeve 109, piezoelectric ceramic plate 1011, backing 108, compression spring 106, and compression nut 105 into the support cylinder 104. Pass the outer end of the lead wire 1013 through the clearance hole 1014 to the outside of the support cylinder 104. Then, tighten the compression nut 105, causing the compression spring 106 to be compressed, thereby fixing the backing 108 inside the support cylinder 104.
C. Inject high-temperature sealing adhesive into the portion of the support cylinder 104 located outside the compression nut 105. After cooling, the high-temperature sealing adhesive forms the rubber block 103, thereby completing the body 1.

For the acoustic communication rod 2: Separately prepare the long tube 203, transmission part 204, connecting plate 206, protective cover 205, and connecting sleeve 201.

The connection process of the transmission part 204, connecting plate 206, protective cover 205, and the long tube 203 is as follows:
A. Weld one end of each cylindrical wire or thin sheet in the transmission part 204 sequentially and evenly onto the connecting plate 206 using agcu brazing.
B. After cooling the transmission part 204 with liquid nitrogen, insert it into the long tube 203.
C. Fix the protective cover 205 to the open end of the long tube 203 via threads. After tightening the threads, perform welding at the groove between the protective cover 205 and the long tube 203 to ensure the integrity and sealing performance of the acoustic communication rod 2, enabling its usage under high-pressure conditions. Once the temperature rises, the transmission part 204 expands and forms a tight fit with the inner cavity of the long tube 203, with the protective cover 205 abutting against the connecting plate 206.

The steel strips of the transmission part 204 are brazed onto the connecting plate 206 using agcu brazing, with the brazing thickness controlled to be ¼ of the ultrasonic wavelength. This ensures excellent acoustic matching. Such a brazing method guarantees that the transmission part 204 remains stable and reliable at temperatures up to 800° c.

The connection process of the connecting sleeve 201 and the long tube 203 is as follows: Sleeve the connecting sleeve 201 over the outer side of the sealed end of the long tube 203, and fix the connecting sleeve 201 to the long tube 203 by welding. During the welding process, ensure that a gap 202 of 0.5˜1 mm is formed between one side of the connecting sleeve 201 and the long tube 203, thereby forming the vent holes.

Step two: Installation of the body 1 and the acoustic communication rod 2

First, apply coupling material evenly on both the outer surface of the bottom end of the support cylinder 104 and the outer surface of the sealed end of the long tube 203. Then, insert the bottom end of the support cylinder 104 into the connecting sleeve 201. The support cylinder 104 and the connecting sleeve 201 are fixedly connected by threads or clamps, with the bottom end of the support cylinder 104 abutting against the sealed end of the long tube 203. Under pressure, the coupling agent flows into the gap 202, thereby expelling the air between the support cylinder 104, the long tube 203, and the connecting sleeve 201 into the gap 202, ensuring that the radiating surface of the body 1 and the acoustic communication rod 2 are tightly fitted together, thereby guaranteeing stable signal transmission.

Due to the presence of the gap 202, when the body 1 is tightened, the coupling agent is compressed and flows into this gap, squeezing out the air between the body 1 and the coupling rod. Without this gap, the residual air at the contact surface would prevent a tight fit between the body 1 and the coupling rod under pressure, ultimately leading to reduced amplitude of acoustic signal transmission and measurement anomalies. At the same time, the gap 202 serves as a decoupling material that isolates pipeline acoustic noise. After the installation of the body 1, the gap 202 effectively functions as a decoupling layer, preventing high-frequency acoustic noise, induced by environmental vibrations in the pipeline, from affecting the measurement when passing through the coupling rod.

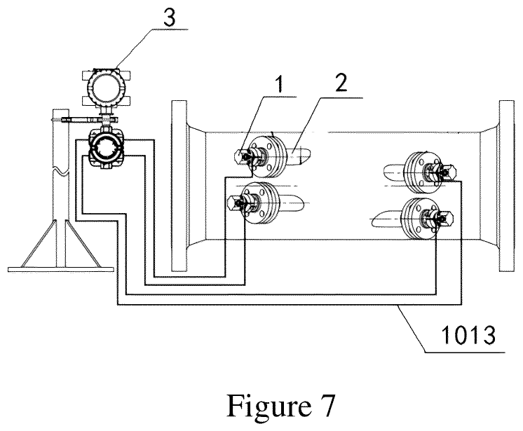

As shown in FIG. 7, the flow measurement device of the present invention comprises a host unit 3 and no less than two transducer sets. Each transducer set includes two transducers as described in this embodiment, with the lead wires 1013 of the transducers connected to the host unit 3. The connection method of the transducers and the fluid pipeline can refer to chinese patent application no. 2022103031383.

### Embodiment 2

Compared to embodiment 1, the mixture contains 2 parts silver powder and 8 parts ab adhesive by mass ratio.

### Embodiment 3

Compared to embodiment 1, the mixture contains 4 parts silver powder and 6 parts ab adhesive by mass ratio.

### Comparative Example 1

Compared to embodiment 1, the acoustic matching layer 1010 is made of plastic.

### Comparative Example 2

Compared to embodiment 1, the acoustic matching layer 1010 is made of peek.

### Comparative Example 3

Compared to embodiment 1, the acoustic matching layer 1010 is made of low-viscosity epoxy resin.

### Comparative Example 4

Compared to embodiment 1, the mixture contains 1 part silver powder and 9 parts ab adhesive by mass ratio.

### Comparative Example 5

Compared to embodiment 1, the mixture contains 5 parts silver powder and 5 parts ab adhesive by mass ratio.

The following table shows the performance parameters of the acoustic matching layer for all embodiments and comparative examples:

| | | | | Comparative | Comparative | Comparative | Comparative | Comparative |
|---|---|---|---|---|---|---|---|---|
| | Embodiment | Embodiment | Embodiment | Example | Example | Example | Example | Example |
| Item | 1 | 2 | 3 | 1 | 2 | 3 | 4 | 5 |
| Impedance | 50 | 1000 | 540 | 13M | 10M | 5.6M | 6.7M | 5.5K |
| (Ω) | | | | | | | | |
| Acoustic | 3.5 × 10⁶ | 7.5 × 10⁶ | 6.3 × 10⁶ | 8.5 × 10⁶ | 6.7 × 10⁶ | 5.5 × 10⁶ | 6.9 × 10⁶ | 7.2 × 10⁶ |
| Impedance | | | | | | | | |
| Rate | | | | | | | | |
| (Pa*s/m) | | | | | | | | |

From the table, it can be observed that the impedance of the acoustic matching layer 1010 in all embodiments is below 1000ω, whereas in the comparative examples, it is above 5.5 kω. All embodiments and comparative examples have acoustic impedance rates within the acceptable range. Therefore, it is evident that the acoustic matching layer 1010 of the transducer in the present invention has a lower impedance and a moderate acoustic impedance rate, resulting in superior electrical and acoustic performance of the transducer. This ensures that the flow measurement device employing the transducer of the present invention delivers accurate and stable measurement results.

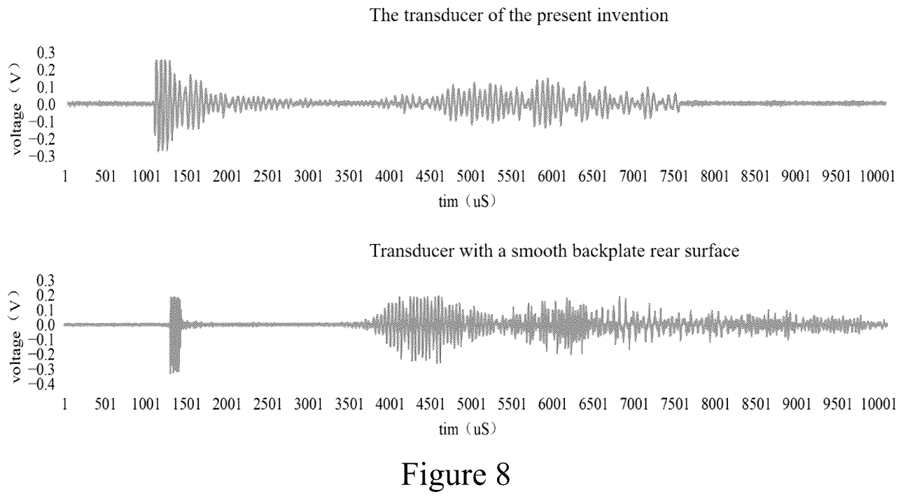

The transducer of embodiment 1 was subjected to a signal-to-noise ratio snr test, and the resulting curve is shown in the upper part of FIG. 8. Subsequently, the backplate of the transducer in embodiment 1 was replaced with a smooth-backplate design, and an snr test was conducted again, yielding the curve shown in the lower part of FIG. 8. The comparison indicates that using a backplate with an irregular rear surface increases the snr of the transducer, thereby stabilizing the testing process of the flow measurement device and ensuring accurate test results. Although using composite materials to fabricate new backplates can also ensure a good snr, the processing technique for composite materials is more complex and less efficient compared to the one-piece machining of the backplate using existing graphite bronze material as described in this invention.

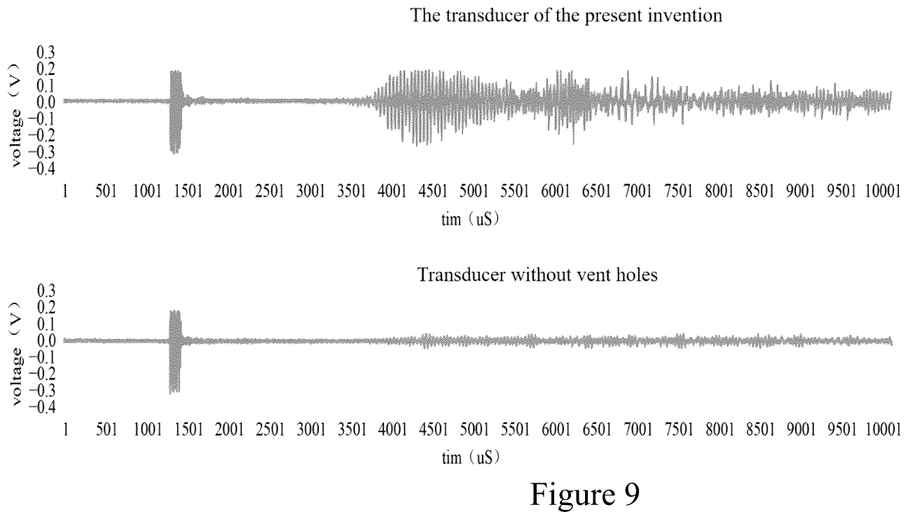

The transducer of embodiment 1 was further tested for receiving signal strength, with the resulting curve shown in the upper part of FIG. 9. During the manufacturing process of the transducer in embodiment 1, the vent holes were removed, resulting in a transducer without vent holes. The receiving signal strength was tested again, and the resulting curve is shown in the lower part of FIG. 9. The comparison reveals that the inclusion of vent holes allows the supporting cylinder and the sealed end of the long tube to fit tightly together, ensuring superior acoustic signal reception, reducing measurement errors, and enhancing measurement stability.

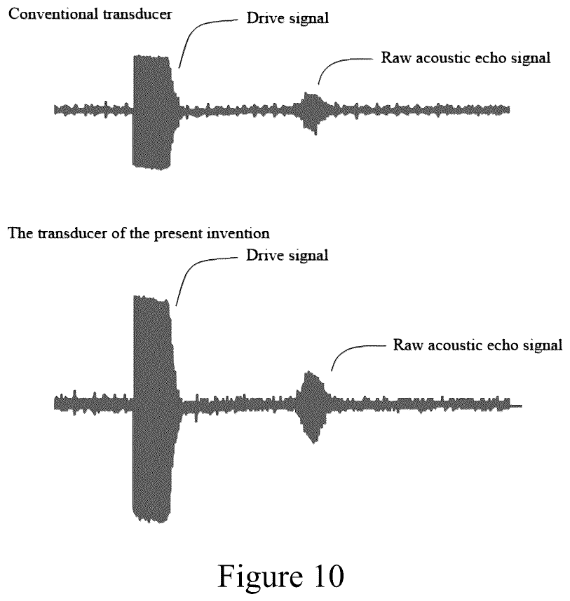

Through practical measurements, as shown in FIG. 10, the raw acoustic echo signals collected by the transducer of the present invention are significantly improved compared to traditional transducers. The output drive signals are also substantially enhanced, thereby considerably increasing the measurement accuracy of the flow measurement device utilizing the transducer of this invention.

What is claimed is:

1. A transducer, comprising a body (1) and an acoustic communication rod (2), wherein the body (1) is fixedly connected to the acoustic communication rod (2), and the radiating surface of the body (1) abuts against one end of the acoustic communication rod (2), thereby achieving signal transmission; characterized in that the acoustic matching layer (1010) of the body (1) is made of a composite material comprising silver and epoxy resin; the composite material contains 2 to 4 parts by weight of silver powder and 6 to 8 parts of AB adhesive; the acoustic communication rod (2) comprises a long tube (203), one end of which, near the body (1), is sealed; a connecting sleeve (201) is sleeved over the sealed end of the long tube (203), with the inner end of the connecting sleeve (201) sleeved over the outer side of the long tube (203), and they are fixedly connected; vent holes are arranged along the axial direction of the acoustic communication rod (2) between the inner wall of the connecting sleeve (201) and the outer wall of the long tube (203), and fix the connecting sleeve (201) to the long tube (203) by welding; during the welding process, ensure that a gap (202) is formed between one side of the connecting sleeve (201) and the long tube (203), thereby forming the vent holes.

2. The transducer according to claim 1, characterized in that the body (1) comprises a housing and a lead wire (1013), wherein the housing includes a support cylinder (104), a cylindrical backing (108) is concentrically arranged within the support cylinder (104), the inner end surface of the backing (108) is a smooth plane, and the outer end surface is irregular with surface pits and dents; a piezoelectric ceramic plate (1011), serving as an acoustic transmitting and receiving element, is adhered to the inner end of the backing (108); the acoustic matching layer (1010) is positioned between the piezoelectric ceramic plate (1011) and the bottom of the inner cavity of the support cylinder (104); a limiting mechanism is provided between the backing (108) and the inner cavity of the support cylinder (104), ensuring that the backing (108), piezoelectric ceramic plate (1011), and acoustic matching layer (1010) are fixed inside the support cylinder (104); one end of the backing (108) is connected to the lead wire (1013), while the other end of the lead wire (1013) passes through the opening of the support cylinder (104) and extends outward; the outer end surface of the bottom of the support cylinder (104) serves as the radiating surface.

3. The transducer according to claim 2, characterized in that the limiting mechanism comprises a limiting sleeve (109) and a compression nut (105); the limiting sleeve (109) is sleeved between the piezoelectric ceramic plate (1011) and the backing (108), with the outer circumferential surface of the limiting sleeve (109) abutting the outer side of the support cylinder (104); an internal thread is formed on the inner circumferential surface of the opening of the support cylinder (104), the compression nut (105) is located within the opening of the support cylinder (104) and threadedly connected thereto, and a compression spring (106) is arranged between the inner side surface of the compression nut (105) and the outer end of the backing (108).

4. The transducer according to claim 3, characterized in that a connecting post (107) extending outward is concentrically arranged on the outer end surface of the backing (108), wherein the outer end of the connecting post (107) is provided with a threaded hole (1012) arranged radially relative to the support cylinder (104); a bolt (1016) is inserted into the threaded hole (1012), and one end of the lead wire (1013) is positioned between the bolt (1016) and the connecting post (107); the compression nut (105) is provided with a clearance hole (1014) through which the lead wire (1013) passes; the other end of the lead wire (1013) passes through the clearance hole (1014) and the opening of the support cylinder (104) to extend outward.

5. The transducer according to claim 4, characterized in that a rubber block (103) is filled inside the portion of the support cylinder (104) located outside the compression nut (105); and the lead wire (1013) passes through the rubber block (103).

6. The transducer according to claim 5, characterized in that the transmission part (204) made of cylindrical wires or thin sheets is filled inside the long tube (203), with one end of the transmission part (204) abutting against the inner surface of the sealed end of the long tube (203); the other end of the transmission part (204) is fixedly provided with a connecting plate (206), which is positioned outside the open end of the long tube (203); a protective cover (205) is provided between the outer side of the connecting plate (206) and the open end of the long tube (203); the bottom end of the support cylinder (104) extends from the outer end of the connecting sleeve (201) into its interior.

7. A manufacturing method for the transducer according to claim 6, characterized by comprising the following steps;
step one: separately manufacture the body (1) and the acoustic communication rod (2);
manufacturing the body (1): separately prepare the support cylinder (104), piezoelectric ceramic plate (1011), backing (108), compression spring (106), limiting sleeve (109), compression nut (105), lead wire (1013), and bolt (1016);
the process of connecting the connecting post (107) and the lead wire (1013) is as follows: one end of the lead wire (1013) is wound around the bolt (1016); then the bolt (1016) is screwed into the threaded hole (1012), thereby clamping the lead wire (1013) onto the connecting post (107);
the installation process is as follows:
A. prepare the acoustic matching layer (1010) at the bottom of the inner cavity of the support cylinder (104); first, mix 2 to 4 parts by weight of silver powder into 6 to 8 parts of ab adhesive and stir evenly to obtain a gel-like composite material; then, uniformly coat the composite material onto the bottom of the inner cavity of the support cylinder (104), with a coating thickness of one-quarter (¼) of the wavelength of the ultrasonic wave; after the composite material coated inside the support cylinder (104) has dried, the acoustic matching layer (1010) is formed;
B. after the preparation of the acoustic matching layer (1010) is completed, sequentially insert the limiting sleeve (109), piezoelectric ceramic plate (1011), backing (108), compression spring (106), and compression nut (105) into the support cylinder (104); pass the outer end of the lead wire (1013) through the clearance hole (1014) to the outside of the support cylinder (104); then, tighten the compression nut (105), causing the compression spring (106) to be compressed, thereby fixing the backing (108) inside the support cylinder (104);
C. inject high-temperature sealing adhesive into the portion of the support cylinder (104) located outside the compression nut (105); after cooling, the high-temperature sealing adhesive forms the rubber block (103), thereby completing the body (1);
for the acoustic communication rod (2): separately prepare the long tube (203), transmission part (204), connecting plate (206), protective cover (205), and connecting sleeve (201); the installation process is as follows;
the connection process of the transmission part (204), connecting plate (206), protective cover (205), and the long tube (203) is as follows:
A. weld one end of each cylindrical wire or thin sheet in the transmission part (204) sequentially and evenly onto the connecting plate (206);
B. after cryogenic treatment, insert the transmission part (204) into the long tube (203);
C. fix the protective cover (205) to the open end of the long tube (203); as the temperature rises, the transmission part (204) expands and closely fits with the inner cavity of the long tube (203), with the protective cover (205) abutting against the connecting plate (206);
the connection process of the connecting sleeve (201) and the long tube (203) is as follows: sleeve the connecting sleeve (201) over the outer side of the sealed end of the long tube (203), and fix the connecting sleeve (201) to the long tube (203) by welding; during the welding process, ensure that a gap (202) is formed between one side of the connecting sleeve (201) and the long tube (203), thereby forming the vent holes;
step two: installation of the body (1) and the acoustic communication rod (2);
first, apply coupling material evenly on both the outer surface of the bottom end of the support cylinder (104) and the outer surface of the sealed end of the long tube (203); then, insert the bottom end of the support cylinder (104) into the connecting sleeve (201); the support cylinder (104) and the connecting sleeve (201) are fixedly connected by threads or clamps, with the bottom end of the support cylinder (104) abutting against the sealed end of the long tube (203); under pressure, the coupling agent flows into the gap (202), thereby expelling the air between the support cylinder (104), the long tube (203), and the connecting sleeve (201) into the gap (202), ensuring that the radiating surface of the body (1) and the acoustic communication rod (2) are tightly fitted together, thereby guaranteeing stable signal transmission.

8. A flow measurement device, comprising a main unit (3) and no fewer than two transducer groups, each transducer group including two transducers, the lead wires (1013) of the transducers are connected to the main unit (3), characterized in that the transducers are those described in claim 1.
